(19) United States
(12) Patent Application Publication
(10) Pub. No.: US 2024/0302270 A1
(43) Pub. Date: Sep. 12, 2024

(54) A SYSTEM AND METHOD FOR IDENTIFYING A BIOLOGICAL SAMPLE IN A SAMPLE HOLDER, AND A BIOPSY DEVICE FOR OBTAINING A BIOLOGICAL SAMPLE OF TISSUE

(71) Applicant: Clearstream Technologies Limited, Enniscorthy (IE)

(72) Inventors: Christopher Norris, Enniscorthy (IE); Prathamesh Sharad Dhanpalwar, Enniscorthy (IE); Luke Bernard Anthony Myles, Enniscorthy (IE)

(21) Appl. No.: 18/573,276

(22) PCT Filed: Jun. 23, 2022
(86) PCT No.: PCT/EP2022/067155

§ 371 Date: Dec. 21, 2023

(30) Foreign Application Priority Data
Jun. 24, 2021 (NL) 2028538

(51) Int. Cl. G01N 21/31; G01N 21/01; G01N 21/35

(52) U.S. Cl. CPC G01N 21/314; G01N 21/01; G01N 21/35; G01N 2021/3181

(57) ABSTRACT

A system for identifying a biological sample in a sample holder. The system comprising a light source for emitting substantially monochrome light directed at the sample holder; a light sensor for detecting the amount of light reflected or transmitted by the biological sample and 5 configured to output measurements indicative of the amount of light detected; and a controller connected to the light sensor and configured to identify the biological sample based on the output measurements of the light sensor.

### TECHNICAL FIELD

The present invention relates to a system for identifying a biological sample in a sample holder and a method for identifying a biological sample in a sample holder.

### BACKGROUND OF THE INVENTION

The detection and identification of diseased tissue is of great importance in modern medicine. Cancer is still one of the leading causes of death worldwide and earlier and simpler detection and identification of tumours could save countless lives.

Cancer is often identified using a biopsy where a small sample of body tissue is taken from a patient in a medical procedure so it can be examined under a microscope. When the tissue sample is examined under the microscope, abnormal cells may be identified, which can help to diagnose a specific condition, such as a tumour. The problem with these procedures is that they are slow, expensive and they require specially trained medical staff to examine the tissue and make a determination of whether the tissue is diseased.

The present invention proposes utilizing the difference in absorption spectra between different tissues and between healthy tissue and malignant tissue to identify the tissue and make a determination of whether the tissue is diseased.

Spectrophotometers for measuring the absorption spectrum of a sample over a range of wavelengths exist in the art. However, these devices are complex and expensive and do not give an automatic identification of the biological sample and whether it relates to a diseased tissue.

There is hence a need in the art for a simple automated system which makes an accurate and quick identification of a biological sample and a determination of whether the biological sample comprises diseased tissue.

### SUMMARY OF THE INVENTION

In a first aspect of the present disclosure, there is provided a system for identifying a biological sample in a sample holder. The system comprises a light source for emitting substantially monochrome light directed at the sample holder; a light sensor for detecting the amount of light reflected or transmitted by the biological sample and configured to output measurements indicative of the amount of light detected. The system further comprises a controller connected to the light sensor and configured to identify the biological sample based on the output measurements of the light sensor.

Throughout this disclosure, ‘substantially monochrome’ light refers to light which has a peak intensity at a predetermined wavelength and a narrow spectral bandwidth. The spectral bandwidth may be less than 200 nm, preferably 100 nm, even more preferably 50 nm. ‘Substantially monochrome’ light may be emitted, for example, by a laser diode or an LED.

Throughout this disclosure, the term ‘identifying a biological sample’ means both identifying a type of tissue, e.g. breast tissue, as well as characterising whether a type of tissue is healthy or diseased, e.g. identifying whether the breast tissue is healthy breast tissue or malignant breast tissue.

In some embodiments, this may result in a system which can automatically identify a biological sample in a cheap, simple and accurate manner.

In some embodiments, this may also allow the automatic determination of a diseased biological tissue in a quick, simple and accurate manner.

The system may further comprise a light blocking structure for holding the sample holder. The light blocking structure may be configured to block any ambient light from reaching the sample when the light blocking structure is holding the sample holder.

In some embodiments, this may result in a reduction of ambient light noise in the light measurements and thereby in a more accurate identification of the biological sample.

The light blocking structure may be non-transparent.

Throughout this disclosure, the term ‘non-transparent’ means that light in the visible and/or infrared spectrum is blocked.

In some embodiments, this may result in a further reduction of ambient light noise and a more accurate identification of the biological sample.

The light blocking structure may comprise a bore for accommodating the sample holder.

In some embodiments, this may result in a further reduction of ambient light noise and a more accurate identification of the biological sample.

In some embodiments, this may also allow the sample holder to be secured within the light blocking structure to give more repeatable and accurate results.

The bore may have a single opening.

The bore may comprise a first section where the bore is wider and a second section where the bore is narrower.

The second section may be disposed further away from the opening of the bore.

In some embodiments, this may allow the sample holder to be easily and quickly inserted and removed from the light blocking structure.

The second section may be configured to engage the sides of the sample holder to hold the sample holder in place.

In some embodiments, this may allow the sample holder to be secured within the light blocking structure to give more repeatable and accurate results.

The bore may have a rectangular cross section.

In some embodiments, this may allow a standard rectangular cuvette to be used as the sample holder.

The light source may be disposed at the opening of the bore and configured to emit the substantially monochromatic light into the bore.

The light detector may be disposed at the opening of the bore. The light detector may be configured to detect the substantially monochromatic light reflected or transmitted by the biological sample in the bore.

In some embodiments, this may result in a simple and robust set-up which can produce repeatable and accurate measurements.

The light blocking structure may further comprise a lid for enclosing the opening of the bore.

The lid may enclose the light source and/or the lid may enclose the light detector such that ambient light is blocked from reaching the sample holder.

Some or all of the light may be blocked from reaching the sample holder.

In some embodiments, this may result in a further reduction of ambient light noise and a more accurate identification of the biological sample.

The light blocking structure may be a 3D-printed structure.

In some embodiments this may result in a simple and cheap reduction of ambient light noise.

The system may comprise the sample holder.

The sample holder may be a cuvette.

The cuvette may comprise a plurality of straight, transparent sides.

In some embodiments, this may reduce measurement errors from refraction and result in a more accurate identification of the biological tissue.

The light source may comprise an LED.

In some embodiments, this may result in a cheap and simple way to emit light with a narrow spectral bandwidth which will give more accurate results when identifying a biological sample.

The light source may comprise an infrared LED.

In some embodiments, infrared light may result in a higher absorption value from biological tissue, making it easier to distinguish between different biological samples.

The light source may comprise a laser diode. The substantially monochromatic light may be a laser light.

In some embodiments, this may result in a highly monochromatic light source which gives a more accurate identification of the biological sample.

The light source may comprise a tuneable laser.

In some embodiments, this may allow the wavelength of the emitted light to be changed such that an absorption value may be determined for a biological sample over a range of wavelengths and thereby give a more accurate identification of the biological sample.

The substantially monochromatic light emitted by the light source may have a peak intensity at a wavelength in the range of 300 nm to 5000 nm.

Preferably, the substantially monochromatic light emitted by the light source may have a peak intensity at a wavelength in the range of 500 nm to 2000 nm.

Even more preferably, the substantially monochromatic light emitted by the light source may have a peak intensity at a wavelength in the range of 800 nm to 1000 nm.

In some embodiments, this range of wavelengths may result in a higher absorption value from biological tissue, making it easier to distinguish between different biological samples.

The substantially monochromatic light emitted by the light source may have a spectral bandwidth below 200 nm.

Preferably, the substantially monochromatic light emitted by the light source may have a spectral bandwidth below 100 nm.

Even more preferably, the substantially monochromatic light emitted by the light source may have a spectral bandwidth below 50 nm.

In some embodiments, this may result in more accurate and repeatable measurements.

The light detector may comprise a photodiode.

In some embodiments, this may result in a cheap and accurate way to detect the amount of light reflected or transmitted by the biological sample.

The photodiode may have a maximum sensitivity at a wavelength in the range of 300 nm to 5000 nm.

Preferably, the photodiode may have a maximum sensitivity at a wavelength in the range of 500 nm to 2000 nm.

Even more preferably, the photodiode may have a maximum sensitivity at a wavelength in the range of 800 nm to 1000 nm.

In some embodiments, this may result in maximum sensitivity of the photodiode coinciding with the peak intensity of the light emitter, giving more accurate measurements.

The light source and the light detector may be provided in a single integrated circuit package.

In some embodiments, this may allow the use of a simple and cheap off-the-shelf sensor package.

The system may further comprise a base support for holding the light source and the light detector.

In some embodiments, this may result in the light source and light detector being held securely in place, result in more repeatable and accurate measurements.

The controller may be configured to calculate an absorption value based on the ratio of the emitted light and the detected light and identify the biological sample based on the absorption value.

In some embodiments, this provides a simple and accurate way of identifying a biological sample.

The controller may be configured to calculate an absorption value based on the output measurements of the light sensor.

The controller may be configured to calculate an absorption value based on the ratio of the output measurement of the light sensor and the maximum output of the light sensor.

The controller may identify the biological tissue from a look-up table of known biological tissues based on the calculated absorption value.

The controller may be configured to make a plurality of measurements using the light sensor and calculate an average absorption value.

In some embodiments, this may result in a more accurate determination of the absorption value.

The system may further comprise a display connectable to the controller for showing the identified biological sample to the user.

In some embodiments, this may allow a user to make a quick and simple identification of the biological sample.

The controller may be further configured to show the measurements acquired by the light sensor on the display.

In some embodiments, this may allow a user to check the accuracy of the measurements.

The system may further comprise an input device connectable to the display and the controller to allow a user to begin taking the measurements of the sample, and/or load previously acquired measurements for analysis, and/or export the measurements to a different programme, and/or clear the measurements.

In some embodiments, this may provide a simple way for the user to control the system and further process the measurement data.

Identifying the biological sample may comprise identifying whether the biological sample relates to a healthy tissue or a diseased or malignant tissue.

In a second aspect of the present disclosure, there is provided a biopsy device for obtaining a biological sample of tissue. The biopsy device comprises a biopsy needle; a sample holder for holding the biological sample; and a system for identifying the biological sample in the sample holder. The system comprises a light source for emitting substantially monochrome light directed at the sample holder; a light sensor for detecting the amount of light reflected or transmitted by the biological sample and configured to output measurements indicative of the amount of light detected. The system further comprises a controller connected to the light sensor and configured to identify the biological sample based on the output measurements of the light sensor.

In some embodiments, this may allow a surgeon to make a quick initial identification of a biological sample obtained with the biopsy device to carry out a more effective biopsy procedure.

The system may further comprise a light blocking structure for holding the sample holder. The light blocking structure may be configured to block any ambient light from reaching the sample when the light blocking structure is holding the sample holder.

In some embodiments, this may result in a reduction of ambient light noise in the light measurements and thereby in a more accurate identification of the biological sample.

The light blocking structure may be non-transparent.

In some embodiments, this may result in a further reduction of ambient light noise and a more accurate identification of the biological sample.

The light source may comprise a laser diode and the substantially monochromatic light may be a laser light.

In some embodiments, this may result in a highly monochromatic light source which gives a more accurate identification of the biological sample.

The substantially monochromatic light emitted by the light source may have a peak intensity at a wavelength in the range of 300 nm to 5000 nm, preferably 500 nm to 2000 nm, even more preferably 800 nm to 1000 nm.

In some embodiments, this range of wavelengths may result in a higher absorption value from biological tissue, making it easier to distinguish between different biological samples.

The substantially monochromatic light emitted by the light source may have a spectral bandwidth below 200 nm, preferably, below 100 nm, even more preferably below 50 nm. In some embodiments, this may result in more accurate and repeatable measurements.

The light detector may comprise a photodiode.

The photodiode may have a maximum sensitivity at a wavelength in the range of the 300 nm to 5000 nm, preferably 500 nm to 2000 nm, even more preferably 800 nm to 1000 nm.

The light source and the light detector may be positioned on the same side of the sample holder.

In some embodiments, this may result in a simple and robust set-up which can produce repeatable and accurate measurements.

The light source and the light detector may be positioned inside the sample holder.

In some embodiments, this may result in more accurate identification of the biological sample.

The light source and the light detector may be provided in a single integrated circuit package.

The controller may be configured to calculate an absorption value based on the ratio of the emitted light and the detected light or calculate an absorption value based on the ratio of the output measurement of the light sensor and a maximum output of the light sensor; and identify the biological sample based on the absorption value.

In some embodiments, this may result in a more accurate determination of the absorption value.

The controller may identify the biological tissue from a look-up table of known biological tissues based on the calculated absorption value.

The controller may be configured to make a plurality of measurements using the light sensor and calculate an average absorption value.

In a second aspect of the present invention, there is provided a method for identifying a biological sample in a sample holder using a system having a light source, a light detector and a controller. The method comprises emitting a light from the light source at a sample within the sample holder; detecting an amount of light reflected or transmitted by the biological sample with the light detector; outputting measurements from the light detector indicative of the amount of light detected to the controller; and identifying the biological sample based on the output signal of the light sensor using the controller.

In some embodiments, this may result in a method which can identify a biological sample in a cheap, simple and accurate manner.

The method may further comprise blocking any ambient light from reaching the sample using a light blocking structure.

In some embodiments, this may result in a reduction of ambient light noise in the light measurements and thereby in a more accurate identification of the biological sample.

Identifying the biological sample may comprise: calculating an absorption value based on the ratio of the emitted light and the detected light; and identifying the biological sample based on the absorption value.

Identifying the biological sample may comprise: calculating an absorption value based on based on the ratio of the output measurement of the light sensor and the maximum output of the light sensor; and identifying the biological sample based on the absorption value.

The absorption value may be an average absorption value based on a plurality of measurements made by the light sensor.

In some embodiments, this may result in a more accurate determination of the absorption value.

Identifying the biological sample may comprise identifying whether the biological sample relates to a healthy tissue or a diseased or malignant tissue.

### BRIEF DESCRIPTION OF THE DRAWINGS

To enable better understanding of the present disclosure, and to show how the same may be carried into effect, reference will now be made, by way of example only, to the accompanying drawings, in which:

FIG. 1 shows an embodiment of a system for identifying a biological sample in a sample holder according to the present disclosure;

FIGS. 2A to 2C show different views of the body portion of a light blocking structure used in the system of FIG. 1;

FIGS. 3A and 3B show different views of the lid of a light blocking structure used in the system of FIG. 1;

FIG. 4 shows a more detailed view of the light blocking structure, base structure and sensor package of FIG. 1;

FIG. 5 shows a block diagram for a graphical user interface for controlling the system of FIG. 1.

FIG. 6 shows a biopsy needle comprising a system for identifying a biological sample in a sample holder according to the present disclosure.

### DETAILED DESCRIPTION

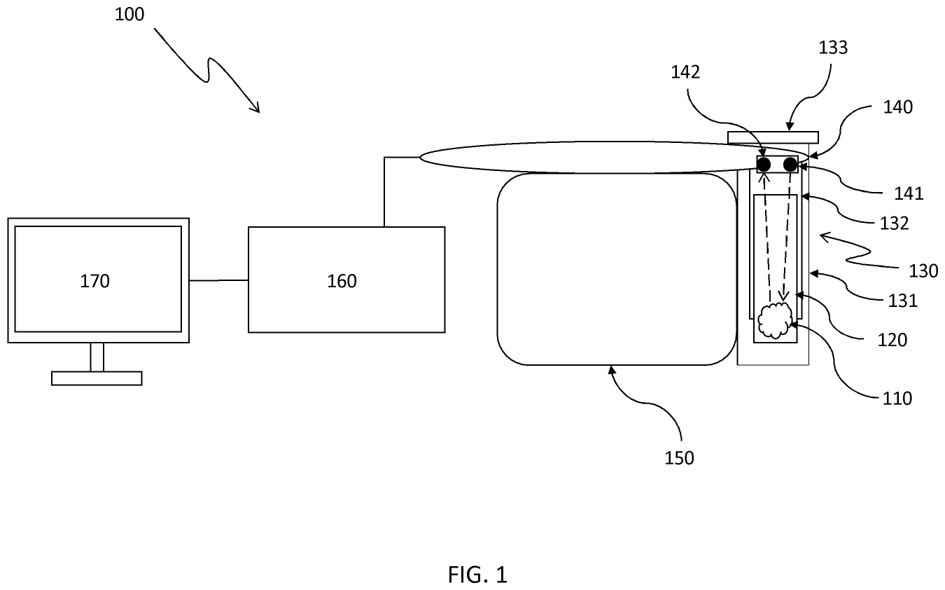

FIG. 1 shows a schematic diagram of a system 100 for identifying a biological sample 110.

The biological sample 110 may be tissue obtained from a human body in a biopsy, for example. The present system 100 can identify the type of tissue and, more importantly, identify whether the tissue is a healthy tissue or a diseased tissue based on the amount of light absorbed by the tissue.

Different tissues have different absorption spectra and absorb different amounts of light at different wavelengths. By shining light at a certain wavelength at the biological sample 110 and measuring the amount of light which is reflected or transmitted and therefore not absorbed by the biological sample 110, a determination of what type of tissue and whether the tissue is diseased can be made. The system 110 can be used, for example, to identify and detect cancerous breast tissue obtained from a biopsy. At a wavelength of 930 nm, malignant breast tissue has a much lower absorption coefficient of about 0.009 mm⁻¹ compared to healthy breast tissue with an absorption coefficient of about 0.02 mm⁻¹. This means that the malignant breast tissue will absorb less light which can be detected by the system 100 and used to identify and detect malignant breast tissue.

In the same manner, tumours in other types of tissues can be detected and the oxygenation levels of blood can be determined.

The biological sample 110 may be placed in a sample holder 120, which may be a cuvette or a test tube. A cuvette is preferred because a standard cuvette has a square or rectangular cross section with straight transparent sides, which reduces the effects of refraction when light is shining onto a sample inside the cuvette.

The sample holder 120 is placed inside a light blocking structure 130. The light blocking structure 130 has a body portion 131 and a lid 133 which are both non-transparent and block any ambient light in the visible and infrared spectrum from reaching the sample 110. The body portion 131 has a rectangular or square shaped bore 132 which extends from an opening on one side of the body portion 131. The sample holder 120 is placed within the bore 132 of the light blocking structure 130.

At least part of the bore 132 is dimensioned such that it engages the sides of the sample holder 120 and secures the sample holder 120 in place such that it cannot move while measurements are taken. This allows more accurate and repeatable measurements to be taken.

The light blocking structure 130 may be made from a number of materials such as a dark coloured non-transparent plastic or a metal. The light blocking structure 130 may be 3D-printed or moulded.

A sensor package 140 comprising a light source in the form of a laser diode 141, such as a Vertical Cavity Surface Emitting Laser (VCSEL), and a light detector in the form of a photodiode 142 is disposed at the opening of the bore 132 and at the top of the body portion 131. The sensor package 140 may be, for example, a Vishay VCNL36887S, which is an off-the-shelf IC package and uses a Vertical Cavity Surface Emitting Laser (VCSEL) as a light source. This allows for simple and cheap construction of the system 100. The laser diode 141 and the photodiode 142 are held in place and supported by a base structure 150. The base structure 150 may be made from plastic and may be a 3D-printed structure. The lid 133 of the light blocking structure 130 is placed over the sensor package and the opening of the bore 132 such that any ambient light is blocked from reaching the sample 110. This results in less ambient light noise when taking measurements and identifying the biological sample 110.

The laser diode 141 emits light which is substantially monochromatic and has a peak intensity at a predetermined wavelength. The light emitted by the laser diode 141 may have a peak intensity at a wavelength in the range of 300 nm to 5000 nm, preferably 500 nm to 2000 nm, even more preferably 800 nm to 1000 nm, even more preferably 930 nm.

It has been shown that a number of biological tissues such as sub-cutaneous human fat and post-menopausal breast tissue have an absorption peak at around 930 nm. This means that if light with a wavelength of around 930 nm is emitted through a sample of human fat or breast tissue, then a greater proportion of the light at that wavelength will be absorbed than at other wavelengths making it easier to evaluate small differences in absorption values between different tissues. A light with a wavelength of around 930 nm will therefore result in greater absorption by the biological sample 120 and more accurate identification of the biological sample 120.

The light emitted by the laser diode 141 has a narrow spectral bandwidth. The spectral bandwidth is defined as band width of the emitted light at half the maximum intensity. A narrower spectral bandwidth will result in light that is more monochromatic and therefore emits more light at a single wavelength compared to other wavelengths. The substantially monochromatic light emitted by the light source may have a spectral bandwidth below 200 nm, preferably below 100 nm, even more preferably below 50 nm. This will also result in more accurate measurements and identification of the biological sample, as the photodiode 142 is influenced by light of other wavelengths.

The photodiode 142 is preferably matched to the wavelength of the laser diode 141, such that the peak or maximum sensitivity of the photodiode 142 is close or identical to the wavelength at which the laser diode 141 emits at a peak intensity.

The photodiode 142 may therefore have a maximum sensitivity at a wavelength in the range of the 300 nm to 5000 nm, preferably 500 nm to 2000 nm, even more preferably 800 nm to 1000 nm, even more preferably 930 nm.

The laser diode 141 and the photodiode 142 are both connected to a controller 160. The controller may be a microcontroller such as the STM32F407VGT6 manufactured by STMicroelectronics, for example.

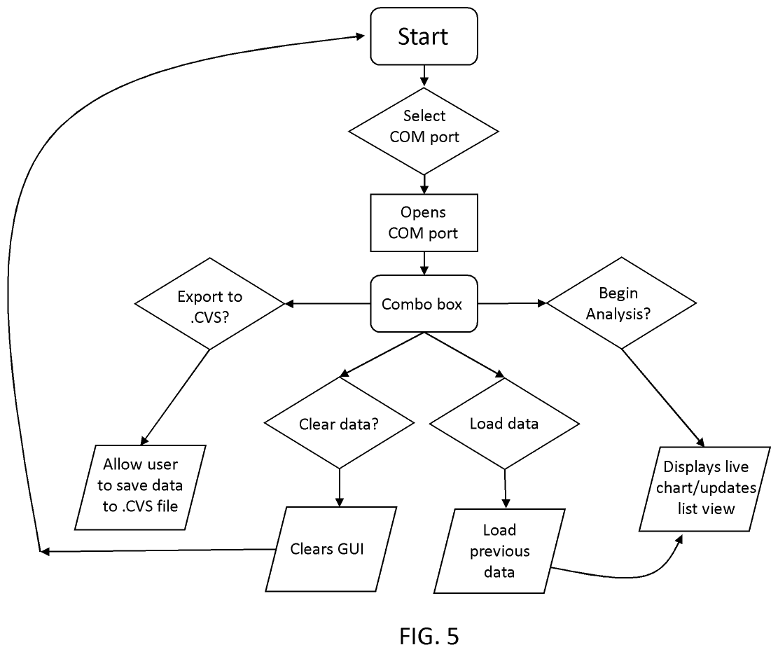

The controller 160 is connected to a display 170 which can show the measurements obtained by the photodiode 142 to a user. The display 170 also comprises an input device to allow a user to provide commands to the controller 160. This input device may be in the form of a touchscreen, a mouse or a keyboard, for example. The input device together with a GUI allows a user to begin the analysis of the biological sample 110 by starting measurements using the laser diode 141 and photodiode 142, load previous measurements of a biological sample, export the measurements as file to an external programme or memory, or clear the measurements (see FIG. 5).

In order to identify the biological sample and determine whether the biological sample 110 is a diseased tissue, a medical practitioner firstly obtains the biological sample 110 from a patient.

The biological sample 110 is then placed into the sample holder 120 which is in turn placed into bore 132 of the body portion 131 of the light blocking structure 130. The bore 132 is sized such that it securely holds the sample holder 120 such that it cannot move while measurements are taken. The sensor package 140 comprising the laser diode 141 and the photodiode 142 is then placed over the opening of the bore 132 and the lid 133 is placed over the sensor package 140 and the opening such that no ambient light can reach the sample 110 in the bore 132.

A user can use the input device and the display 170 to start the analysis of the biological sample 110. This will cause the controller 160 to turn on the laser diode 141 which emits substantially monochromatic light directed into the bore 132 towards the biological sample 110. When the light hits the sample 110, some of the light will be absorbed by the sample 110, while some of the light will be reflected by the sample 110.

The amount of light which is reflected by the sample 110 is then detected by the photodiode 142. The photodiode 142 turns the amount of light detected into an electrical signal, which may be in the form of a voltage or a current, which is then sent to the controller 160.

The controller 160 will then calculate an absorption value for the biological sample based on the ratio of the known intensity of emitted light from the laser diode 141 and the light detected by the photodiode 142. Alternatively, the controller 160 will calculate an absorption value based on the output measurements of the photodiode 142, alone, for example, by calculating an absorption value based on the ratio of the output measurement of the photodiode 142 and the maximum output of the photodiode 142.

The photodiode 142 may take several separate measurements over a pre-determined time period and send these to the controller. The controller can then calculate an average absorption value for the biological sample 110 based on the plurality of measurements taken.

Based on the determined absorption value for the biological sample 110 and the known wavelength of light emitted by the laser diode 141, the controller 160 can then identify the biological sample 110. For example, the controller may determine whether the biological sample is healthy breast tissue or a malignant breast tissue. This can be done, for example, by the controller 160 consulting a look-up table of known absorption values and wavelengths, consulting an external database, or using pre-determined upper and lower limits for the absorption value based on empirical data.

The measurements obtained by the photodiode 142 together with the calculated absorption values and the identified biological sample 110 are then displayed on display 170. The user can then use the input device to export the data to a different programme for further processing or an external memory for storage. Alternatively, the user can clear the data and start a new analysis of the biological sample 110 or load data from a previous analysis of a different biological sample.

The present system 100 therefore provides automated system for identifying a biological sample in a quick and accurate manner and allows a determination of whether the sample is a diseased tissue. The system 100 is simple to use, robust and cheap to make and can provide accurate determination of diseased biological tissue. The sensor package 140 and the controller 160 can be relatively cheap off-the-shelf IC components. The light blocking structure 130 and the base structure 150 can be 3D-printed structures. The present system can therefore provide an accurate and automated identification of a biological sample at a fraction of the cost of a spectrophotometer and without the training required to perform a biopsy and tissue analysis using a microscope.

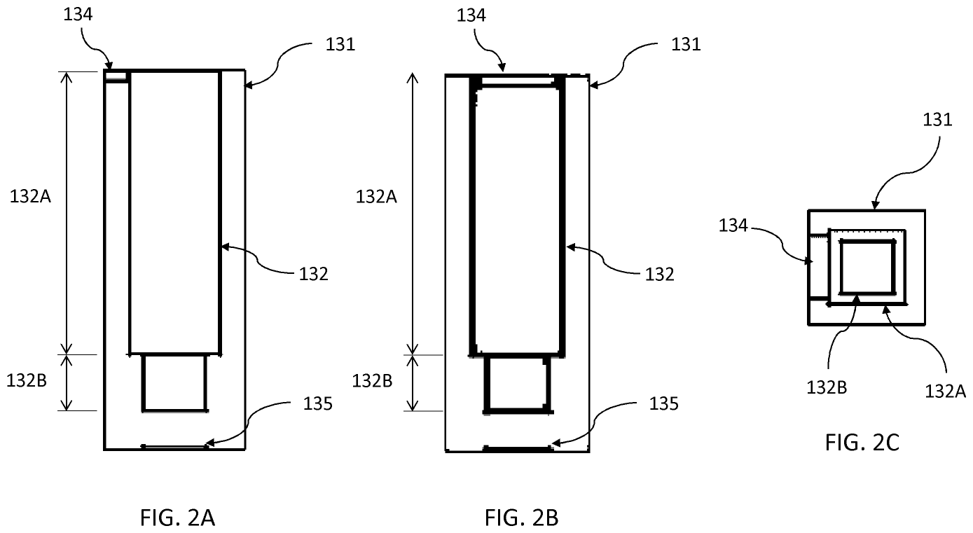

FIGS. 2A to 2C show different detailed views of the body portion 131 of the light blocking structure 130. FIG. 2A is a cross-sectional side view of the body portion 131 and FIG. 2B shows a cross-sectional front view of the body portion 131.

As shown in FIGS. 2A and 2B, the body portion 131 is in the shape of a cuboid and comprises a bore 132 which extends partly through the body portion 131. The bore 132 has a single opening on one side of the body portion 131. The cross-section of the bore is square or rectangular, as shown in FIG. 2C, and the bore 132 comprises a first section 132A and a second section 132B. The first section 132A starts at the opening and is wider than the second section 132B which is further away from the opening. The diagonal width of the bore of the first section 132A is therefore greater than the diagonal width of the bore of the second section 132B. The second section 132B is dimensioned to engage the sides of the sample holder 120, which in this case is a standard size cuvette. This means that the cuvette is secured inside the body portion 131 and cannot move while the measurements on the sample 110 are made. The first section 132A is wider to allow the cuvette to be easily inserted and removed from the body portion 132.

The body portion 131 further comprises a side opening 134 which is connected to the opening of the bore 132 from a side of the body portion 131. The side opening 134 may be in the form of a slit or a channel. The side opening allows the sensor package 140 including the laser diode 141 and the photodiode 142 to be placed over the opening of the bore 142. Wires from the sensor package 140 can enter and exit the light blocking structure 130 through the side opening 134.

The body portion 131 also comprises a square indentation at the bottom, opposite the opening of the bore 132. This groove is optional but may be used to engage a corresponding raised portion to stabilise and secure the body portion 131.

FIG. 2C shows a top view of the body portion 131. This clearly shows the rectangular or square cross-section of the body portion 131 as well as the square cross-section of the first section 132A and the second section 132B and also shows that the diagonal width of the second section 132B is smaller than the first section 132A. The side opening 134 which connects the opening of the bore 132 to an orthogonal side of the body portion 131 is also shown.

As mentioned above, the body portion may be made from a non-transparent material such as a plastic or metal and may be 3D-printed or moulded, for example.

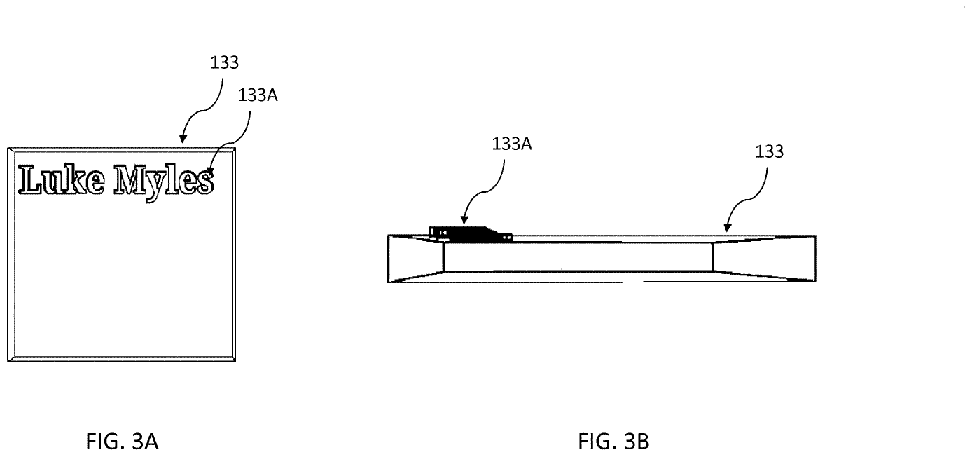

FIG. 3A shows a top view of the lid 133 of the light blocking structure. The lid is non-transparent square-shaped element which dimensioned to fit over the opening of the bore 132 and enclose the sensor package 140, including the laser diode 141 and the photodiode 142, such that no ambient light can reach the biological sample 110. The lid 133 may be provided with insignia 133A.

FIG. 3B shows a perspective side view of the lid 133.

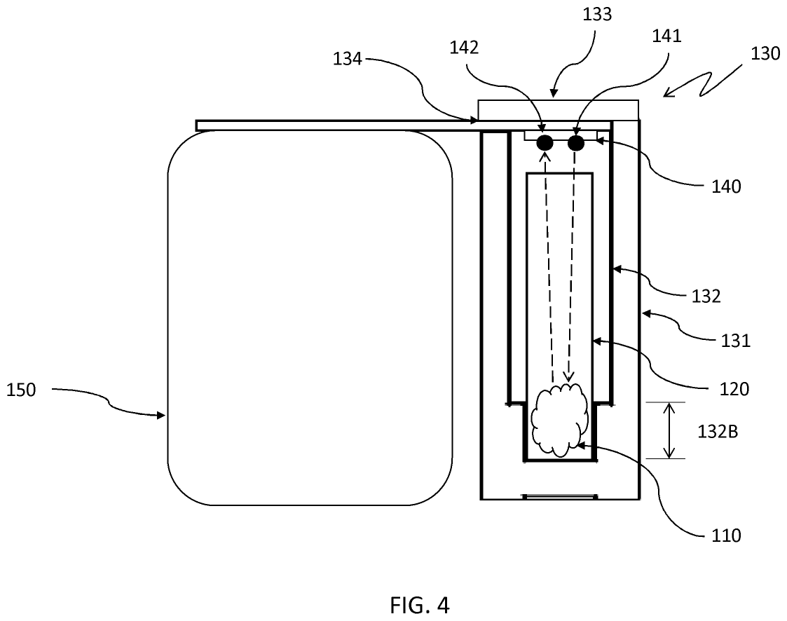

FIG. 4 shows a schematic close-up view of the arrangement of the light blocking structure 130, sensor package 140 and base structure 150. As already mentioned with respect to FIG. 1, the biological sample 110 is placed in the sample holder 120 which is placed within the bore 132 of the light blocking structure. FIG. 4 shows how the second section 132B of the bore 132 engages the bottom of the sample holder 120 and holds it in place.

The sensor package is placed at the top of the body portion 131 over the opening of the bore 132 so that the laser diode 141 can emit light into the bore 132 and the photodiode can detect the reflected light coming from the sample 110 in the bore 132. Part of the sensor package can extend through the side opening 134 out of the light blocking structure 130 and is secured to the base structure to hold the sensor package 140 in place. Alternatively, the entire sensor package 140 can be disposed inside the light blocking structure and only an element carrying the wires connecting the sensor package 140 to the controller 160 extends through the side opening 134 and is secured to the base structure 150. The lid 133 is placed over the opening of the bore and the sensor package 140 to block any ambient light from entering the bore 132 and reaching the sample 110.

FIG. 5 shows a block diagram for a graphical user interface (GUI) used to control the system 100.

At the start, the GUI allows the user to select a communications (COM) port of the controller 160. The controller 160 may have a plurality of COM ports which can be connected to different sensor packages 140. For example, multiple sensor packages having light sources with different wavelengths can be used, and measurements of the sample can be made at different wavelengths of light.

The controller 160 will then open the selected COM port and the GUI will present the user with a combo box. The user will then be able to select from a number of different options.

The user may select ‘Begin Analysis?’ which results in the controller 160 sending instructions to the sensor package 140 to start taking measurements of the biological sample 110. The display 170 will display the live measurements taken from the photodiode 142 as well as the identified biological sample.

If the user selects ‘Load data’, previous measurement data may be loaded and displayed as a chart on the display 170.

If the user selects ‘Clear Data’, the measurement data present on the GUI will be cleared and the GUI will take the user back to the start.

If the user selects ‘Export to .CVS?’, the measurement data obtained from the photodiode 142 and the controller 160 may be saved as a .CVS file to a memory device. The data may then be loaded into programme for reanalysis or used in a different programme for further analysis.

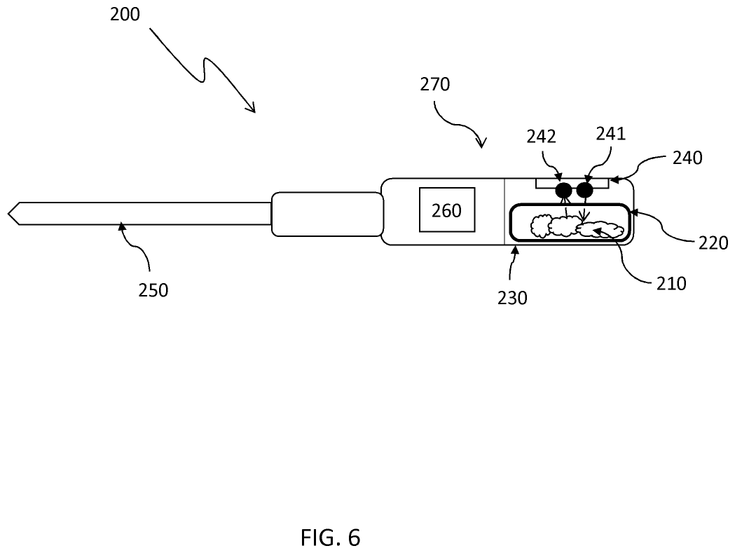

FIG. 6 shows a schematic illustration of a biopsy device 200 with an integrated system for identifying a biological sample obtained by the biopsy device. The biopsy device 200 comprises a biopsy needle 250 for obtaining a biological sample 210 of tissue from a patient. This biological sample 210 may be a breast tissue, for example.

The biopsy device 200 further comprises a sample holder 220 for holding the biological sample 210 obtained with the biopsy needle 250. The sample holder 220 may be disposed in a handle 270 of the biopsy device 200. The biological sample 210 can be transported from the biopsy needle 250 to the sample holder 220 with a vacuum suction device (not shown), which will pull the biological tissue 210 from the biopsy needle 250 into the sample holder 220. The sample holder 220 is disposed within a light blocking structure 230 which is non-transparent and blocks ambient light from reaching the sample holder 220 and biological sample 210. The sample holder 220 may be removable from the light blocking structure 230. A sensor package 240 comprising a light source in the form of a laser diode 241, such as a Vertical Cavity Surface Emitting Laser (VCSEL), and a light detector in the form of a photodiode 242 is also positioned within the light blocking structure 230 on one side of the sample holder 220. The sensor package 240 may be same as sensor package 140 of FIGS. 1 to 4.

The sensor package 240 may be positioned within the light blocking structure 230 but outside of the sample holder 220 such that the light emitted by the laser diode 241 passes through the transparent sample holder 220 before it is absorbed or reflected by the biological sample 210. The reflected light is then detected by the photodiode 242. The sensor package 240 may remain fixed within the light blocking structure 230 while the sample holder 220 can be removed or replaced.

The biopsy device 200 further comprises a controller 260 which is connected to the laser diode 241 and photodiode 242 of sensor package 240. The controller 260 may be identical to controller 160 of FIGS. 1 to 4 and may also be configured to calculate an absorption value for the biological sample 210. For example, this absorption value may be calculated based on the ratio of the known intensity of emitted light from the laser diode 241 and the light detected by the photodiode 242 or based on the output measurements of the photodiode 242, alone, for example, by calculating an absorption value based on the ratio of the output measurement of the photodiode 242 and the maximum output of the photodiode 242. Based on the determined absorption value for the biological sample 210 and the known wavelength of light emitted by the laser diode 241, the controller 260 can then identify the biological sample 210. For example, the controller 260 may determine whether the biological sample is healthy breast tissue or a malignant breast tissue. The controller 260 may be connected to an external display (not shown) or an integrated display (not shown) which can indicate the identified biological tissue to the surgeon. The display may also comprise an input device to allow a user to provide commands to the controller 260.

A surgeon may use the biopsy device 200 to obtain a biological tissue sample, such as biological sample 210, from a patient and obtain a quick initial indication of the type of biological tissue of the biological sample 210, for example, whether the biological sample 210 is a healthy or malignant tissue. This can allow the surgeon to make a more informed decision as to whether another biopsy is necessary before sending the biological sample to a lab to be analysed and waiting for the results. The biopsy device 200 can therefore help to make a biopsy procedure more effective and efficient for the surgeon and patient.

Various modifications will be apparent to those skilled in the art.

The sample holder 120 may be a cuvette, a test tube, or any other type of suitable vehicle for holding a biological sample.

The system 100 may not comprise a light blocking structure 130.

The light blocking structure 130 may not be cuboid shaped but may be any other suitable shape, such as, for example, spherical, pyramidal.

The bore 132 of the body portion 131 may not comprise a first section 132A and a second section 132B but rather may be a single bore with a constant width.

The light blocking structure 130, 230 may be made from any material which is non-transparent and can block ambient visible and infrared light and is not limited to plastics or metals.

The light blocking structure 130 may be made in any suitable way and is not limited to 3D printing or moulding.

The light blocking structure 130 may not have an indentation 135 or a side opening 134.

The bore 132 is not limited to a square cross-sectional shape but may take other shapes such as a round or triangular cross-sectional shape, for example.

The light blocking structure may not comprise a lid 133.

The lid 133 is not limited to any particular shape, as long as it can block ambient light from entering the bore 132.

The system may not comprise a base structure 150.

The base structure 150 may be made from any suitable material and is not limited to plastic.

The base structure 150 may also be made from any suitable manufacturing method.

The laser diode 141, 241 and the photodiode 142, 242 may not be provided in the same sensor package 140, 240 but may be separate components, provided in individual packages.

The light source is not limited to a laser diode 141, 241 but may be an LED or a tuneable laser, for example.

The light detector is not limited to a photodiode 142, 242 but may be a different light detector such as a photoresistor, a photomultiplier tube (PMT), a charge coupled device (CCD) or any other suitable light detector.

The controller 160, 260 may be a microcontroller or any other type of suitable processor which can store and manipulate data, such as a PC, for example.

The system 100 may not comprise a display 170.

The display 170 may be a touchscreen or a standard display 170.

The system 100 may not comprise an input device.

The biopsy device 200 may not comprise a vacuum suction device. The biological sample 210 may be transported from the needle 250 to the sample holder 220 via other means, such as gravity, for example.

The biopsy device 200 may not comprise a light blocking structure 230.

The sensor package 240 may be positioned on the inside of the sample holder 220 such that the light emitted from the laser diode 241 does not pass through the sample holder 220.

The sensor package 240 may be positioned at any one side of the sample holder 220.

The laser diode 241 and photodiode 242 may be positioned at opposite sides of the sample holder 220.

The sample holder 220 may not be positioned in the handle 270 of the biopsy device 200 but may be positioned at another suitable location. The controller 260 may not be positioned in the handle 270 but may also be positioned at another suitable location.

The biopsy device 200 may not comprise a display. Rather, the biopsy device 200 may comprise another type of indicator, for example, in the form of indicator lights, to indicate the type of biological tissue to a user.

All of the above are fully within the scope of the present disclosure and are considered to form the basis for alternative embodiments in which one or more combinations of the above described features are applied, without limitation to the specific combination disclosed above.

In light of this, there will be many alternatives which implement the teaching of the present disclosure. It is expected that one skilled in the art will be able to modify and adapt the above disclosure to suit its own circumstances and requirements within the scope of the present disclosure, while retaining some or all technical effects of the same, either disclosed or derivable from the above, in light of his common general knowledge in this art. All such equivalents, modifications or adaptations fall within the scope of the present disclosure.

1. A system for identifying a biological sample in a sample holder, the system comprising:
a light source for emitting substantially monochrome light directed at the sample holder;
a light sensor for detecting an amount of light reflected or transmitted by the biological sample and configured to output measurements indicative of the amount of light detected; and
a controller connected to the light sensor and configured to identify the biological sample based on the output measurements of the light sensor.

2. The system of claim 1, further comprising a light blocking structure for holding the sample holder, which is configured to block any ambient light from reaching the biological sample when the light blocking structure is holding the sample holder.

3. The system of claim 2, wherein the light blocking structure is non-transparent.

4. The system of claim 2, wherein the light blocking structure comprises a bore for accommodating the sample holder.

5. The system of claim 4, wherein the bore has a single opening.

6. The system of claim 4, wherein the bore comprises a first section where the bore is wider and a second section where the bore is narrower.

7. The system of claim 6, wherein the second section is disposed further away from the opening of the bore.

8. The system of claim 6, wherein the second section is configured to engage sides of the sample holder to hold the sample holder in place.

9. The system of claim 4, wherein the bore has a rectangular cross section.

10. The system of claim 4, wherein the light source is disposed at the opening of the bore and configured to emit the substantially monochrome light into the bore.

11. The system of claim 4, wherein the light sensor is disposed at the opening of the bore and configured to detect the substantially monochrome light reflected or transmitted by the biological sample in the bore.

12. The system of claim 10, wherein the light blocking structure further comprises a lid for enclosing the opening of the bore, the light source and/or the light sensor such that ambient light is blocked from reaching the sample holder.

13. The system of claim 2, wherein the light blocking structure is a 3D-printed structure.

14. The system of claim 1, wherein the system comprises the sample holder.

15. The system of claim 1, wherein the sample holder is a cuvette.

16. The system of claim 15, wherein the cuvette comprises a plurality of straight, transparent sides.

17. The system of claim 1, wherein the light source comprises a laser diode and the substantially monochrome light is a laser light.

18. The system of claim 1, wherein the light source comprises a tuneable laser.

19. The system of claim 1, wherein the light source comprises an LED.

20. The system of claim 17, wherein the light source comprises an infrared LED.

21. The system of claim 1, wherein the substantially monochrome light emitted by the light source has a peak intensity at a wavelength in a range of 300 nm to 5000 nm.

22. The system of claim 1, wherein the substantially monochrome light emitted by the light source has a spectral bandwidth below 200 nm.

23. The system of claim 1, wherein the light sensor comprises a photodiode.

24. The system of claim 23, wherein the photodiode has a maximum sensitivity at a wavelength in a range of the 300 nm to 5000 nm.

25. The system of claim 1, wherein the light source and the light sensor are provided in a single integrated circuit package.

26. The system of claim 1, further comprising a base support for holding the light source and the light sensor.

27. The system of claim 1, wherein the controller is configured to:
calculate an absorption value based on a ratio of the emitted light and the detected light or calculate an absorption value based on a ratio of an output measurement of the light sensor and a maximum output of the light sensor; and
identify the biological sample based on the absorption value.

28. The system of claim 27, wherein the controller identifies biological tissue from a look-up table of known biological tissues based on the calculated absorption value.

29. The system of claim 27, wherein the controller is configured to make a plurality of measurements using the light sensor and calculate an average absorption value.

30. The system of claim 1, further comprising a display connectable to the controller for showing the identified biological sample to a user.

31. The system of claim 21, wherein the controller is further configured to show the measurements acquired by the light sensor on a display.

32. The system of claim 31, further comprising an input device connectable to the display and the controller to allow a user to begin taking the measurements of the biological sample, and/or load previously acquired measurements for analysis, and/or export the measurements to a different program, and/or clear the measurements.

33. A biopsy device for obtaining a biological sample of tissue, the biopsy device comprising:
a biopsy needle;
a sample holder for holding the biological sample; and
a system for identifying the biological sample in the sample holder, the system comprising:
a light source for emitting substantially monochrome light directed at the sample holder;
a light sensor for detecting an amount of light reflected or transmitted by the biological sample and configured to output measurements indicative of the amount of light detected; and
a controller connected to the light sensor and configured to identify the biological sample based on the output measurements of the light sensor.

34. The biopsy device of claim 33, wherein the light source comprises a laser diode and the substantially monochrome light is a laser light.

35. The biopsy device of claim 33, wherein the substantially monochrome light emitted by the light source has a peak intensity at a wavelength in a range of 300 nm to 5000 nm.

36. The biopsy device of claim 33, wherein the substantially monochrome light emitted by the light source has a spectral bandwidth below 200 nm.

37. The biopsy device of claim 33, wherein the light sensor comprises a photodiode.

38. The biopsy device of claim 37, wherein the photodiode has a maximum sensitivity at a wavelength in a range of the 300 nm to 5000 nm.

39. The biopsy device of claim 33, wherein the light source and the light sensor are positioned on the same side of the sample holder.

40. The biopsy device of claim 33, wherein the light source and the light sensor are provided in a single integrated circuit package.

41. The biopsy device of claim 33, wherein the controller is configured to:
calculate an absorption value based on a ratio of the emitted light and the detected light or calculate an absorption value based on a ratio of an output measurement of the light sensor and a maximum output of the light sensor; and
identify the biological sample based on the absorption value.

42. The biopsy device of claim 41, wherein the controller identifies biological tissue from a look-up table of known biological tissues based on the calculated absorption value.

43. The biopsy device of claim 41, wherein the controller is configured to make a plurality of measurements using the light sensor and calculate an average absorption value.

44. A method for identifying a biological sample in a sample holder using a system having a light source, a light detector and a controller, the method comprising:
emitting a light from the light source at a sample within the sample holder;
detecting an amount of light reflected or transmitted by the biological sample with the light sensor;
outputting measurements from the light detector indicative of the amount of light detected to the controller; and
identifying the biological sample based on the output signal of the light sensor using the controller.

45. The method of claim 44, further comprising blocking any ambient light from reaching the sample using a light blocking structure.

46. The method of claim 44, wherein identifying the biological sample comprises:
calculating an absorption value based on a ratio of the emitted light and the detected or calculating an absorption value based on a ratio of an output measurement of the light sensor and a maximum output of the light sensor; and
identifying the biological sample based on the absorption value.

47. The method of claim 46, wherein the absorption value is an average absorption value based on a plurality of measurements made by the light sensor.
